(19) United States
(12) Patent Application Publication
(10) Pub. No.: US 2007/0094252 A1
(43) Pub. Date: Apr. 26, 2007

(54) ImageRank

(76) Inventors: Thomas Denis Donnelly, Coventry (GB); Vanessa Anne Donnelly, Coventry (GB); Lawrence Jonathon Gould, London (GB); Elizabeth Reine Gould, London (GB)

Correspondence Address: THOMAS D. DONNELLY, 58 LEAMINGTON ROAD, COVENTRY, CV3-6CS, GB

(21) Appl. No.: 11/270,106

(22) Filed: Nov. 10, 2005

(30) Foreign Application Priority Data
Oct. 25, 2005 (GB) 0521690.8

(51) Int. Cl. G06F 17/30

(52) U.S. Cl. 707/5

(57) ABSTRACT

1. ImageRank is an heuristic methodology for incorporating user interaction with the results of a search for images in order to enhance the relevance of future search results. 2. ImageRank incorporates several other derivative factors such as user history, image history, image-source history, temporal data and the relationship between the image and the successful terminology used to locate that image. Success is iterative-based and determined by (1) above and its derivatives. 3. ImageRank provides for a methodology that records all of the successful and unsuccessful search criteria ever deployed to locate an image described in (1) above and its derivatives as described in (2) above. This recorded history is exploited in order to track the changing use and meaning of words in languages to provide an

### OVERVIEW

Image databases are usually classified with a controlled taxonomy to assist in searching the collection for the most appropriate image.

Many aspects of image descriptions are absolute such as subject matter; for example, a picture of a Dog would be tagged with “Dog”. Other criteria, such as concepts are more subjective. For example, one might interpret an image of people running as “excitement”, another interpretation might be “speed” or “anxiety”. Each image usually has multiple tags to ensure that many aspects of an image can be meta-tagged against a single image.

The opportunity for human error or personal tastes influencing the categorisation is considerable. ImageRank is an heuristic method that captures human interaction with the results of a taxonomy-based search and applies a “weighting-index” or ImageRank against an image that is based on user-determined relevance.

### THE PROBLEM

Databases are a convenient way of storing often many millions of digitised images or references to physical images to assist in the classification and subsequent search and retrieval of an image when it is impractical or inconvenient to view each and every image in the collection.

Many image databases provide search criteria to locate the most appropriate image for a user's needs. The criteria are often based on semantic data and conceptual information. These data are often inconsistent across image collections and this disparity is compounded further by the often-subjective interpretation of image attributes such as emotional concepts. While a lexicon of synonym relationships are often deployed to cater for ambiguity, one man's “excitement” will always be another man's “overreaction”.

### THE SOLUTION AND METHOD

As image collections are searched, a useful catalogue of information about the images is generated in parallel. For example, as search results are displayed, users are often given the choice of remembering certain images as “favourites”. If a user performs a search against certain criteria, views the images found in the results and then elects to add certain images to their “favourites” or “preferred” list, this would be an empirical unit of evidence (or vote) that the image demonstrated a high degree of relevancy with the search criteria deployed. These retained lists of preferred images are often called by metaphorical industry names such as “light box”, “digital light-box” or “portfolio” and they assist users in retaining search results as part of an iterative process in locating the desired image. They are the “common currency” of online commercial stock photographic collections of licensable imagery.

These unprompted and involuntary judgements are a by-product of the light-box facility and can be combined with a number of other criteria or Factors, some of which include (but are not limited to) the following:

Image History as an ImageRank Factor

The ImageRank of each selection will be enhanced if the image has previously been licensed in a commercial transaction. The more times an image has been licensed, the higher its ImageRank might be. Furthermore, the type of use for which an image has been licensed will provide further weight to its imageRank. If an image has a successful history in being licensed for creative use in advertising, then any search for that type of image with a user-specified application of “Advertising” would provide a stronger match.

User History as an ImageRank Factor

The user's previous interaction history in selecting and licensing images would augment the evidence provided by adding an image to a “light-box”. If a user has licensed a significant quantity of imagery, then a higher ImageRank would be attached to their selections than for a user who had no voting history.

Image Source as an ImageRank Factor

The creator of the image would provide further data to calculate the ImageRank; successful sources of imagery would provide greater weighting than unsuccessful sources.

Temporal Data as an ImageRank Factor

Temporal data will assist in providing a computational decay mechanism for imagery and/or its metadata as trends or fashions change. Thus fashion images that are 10 or more years old might not yield such a high ImageRank when searching for contemporary clothing images. Images of a flooded city after a hurricane has struck will have a high-degree of relevancy against the name of the city while the effects of the hurricane are still present, but that temporal relationship should be diluted as the event passes into history.

Search Criteria as an ImageRank Factor

When classifying an image with keywords, many systems impose a hierarchy or weighting against each word. An image of a man holding a dog may provide equal weght to the terms “man” and “dog”. In ImageRank, the terms that have resulted in the image being selected and licensed are recorded and mapped to the image as a relationship. This may reveal that although the image contains a picture of a man and a dog with equal prominence, it is the image of the dog that is providing the most effective match when the terms “man” or “dog” are used.

Search Criteria to Track the Changing use of Words and Language

Any taxonomy can track the introduction of new words through synonym relationships in the controlled vocabulary, but the ability to track and change your classification system to accommodate the changing use of language is difficult if not impractical. The organic nature of languages forces change on the meaning and relevancy of words over time. ImageRank's methodology includes the ability to record the entire search criteria ever utilised in identifying a relevant image. This absolute record of keywords to images will provide valuable empirical data on the use of language and its relevance to images and their content. Consistent use of keywords to locate an image that are not used to tag that image will alert the taxonomy system to learn a new keyword for that entry. Failure is turned into success.

Furthermore, as older anachronistic keywords decline in usage, this temporal data will be used to decrease the relevancy of images meta-tagged with the older terms.

This organic-tracking will obviate the need to track language changes and re-classify images as the use of words and concepts change (e.g. “cool” as in temperature to “cool” as “groovy” and “wicked” as in “evil” to “wicked” as in “excellent”). Although the recorded data against each image may be considerable, the cost of these storage systems now makes this a viable proposition.

Summary

It is to be expected that data from user interaction with imagery will provide relevance ranking that transcends a taxonomy-only reference.

Augmenting ImageRank with additional empirical data such as the history of the user. the image, the image-source and image application as well as data to decay or enhance relevance such as temporal information will provide an heuristic ranking systems that enhances considerably the taxonomy-only systems.

As the use of words and their meanings change, ImageRank's recorded history of the keywords used to locate a ranked image will provide an organic migration to the new relevancy of keywords and their relationship to the images with which they have been originally tagged. The evolving nature of language is modelled in the ImageRank methodology, eliminating manual and intensive analysis of the changing use of words and their intended meanings.

ImageRank is ultimately the perfect organic search methodology that is by definition optimised for the market it serves and is in constant synchronicity with the use of the language deployed to locate images.

What is claimed is:

1. A methodology for searching lists or databases of images that incorporates data from user interaction with the search results in order to influence and improve future search results.

2. The process by which the methodology in (1) above is influenced by the past history of user interaction with the image database in determining the relevance of an image in search results.

3. The process by Which the methodology in (1) above is influenced by the prior commercial success and use of an image in determining the relevance of an image in search results.

4. The process by which the methodology in (1) above is influenced by the prior commercial success of an image's source in determining the relevance of an image in search results.

5. The process by which the methodology in (1) above is influenced by temporal data to enhance or dilute the relevance of an image in search results.

6. The process by which all the search criteria ever used to locate an image are stored and related to the image to enhance future search activity.

7. The method by which all the search criteria ever used to locate an image are stored and related to an image's history and used to track linguistic changes in the use and meaning of key words and their relationship to images in order to improve on the defined taxonomy structure within a search engine.
